(19) United States
(12) Patent Application Publication
(10) Pub. No.: US 2015/0281538 A1
(43) Pub. Date: Oct. 1, 2015

(54) MULTI-ARRAY IMAGING SYSTEMS AND METHODS

(71) Applicant: Semiconductor Components Industries, LLC, Phoenix, AZ (US)

(72) Inventors: Ulrich Boettiger, Garden City, ID (US); Swarnal Borthakur, Boise, ID (US); Marc Sulfridge, Boise, ID (US); Rick Lake, Meridian, ID (US)

(21) Appl. No.: 14/225,129

(22) Filed: Mar. 25, 2014

(51) Int. Cl. H04N 5/225; H04N 9/097; H04N 5/232

(52) U.S. Cl. CPC H04N 5/2258; H04N 5/2257; H04N 5/23232; H04N 9/097

(57) ABSTRACT

An imaging system may include multiple imaging arrays. One or more of the arrays may be a low-power array that detects trigger events in observed scenes and, in response to the detection of a trigger event, activates one or more primary imaging arrays. One or more of the arrays may be a polarization sensing array, a hyperspectral array, a stacked photodiode array, a wavefront sensing array, a monochrome array, a single color array, a dual color array, or a full color array. In at least one embodiment, image data from a stacked photodiode imaging array may be enhanced using image data from a separate monochrome imaging array. In at least another embodiment, image data from a wavefront sensing array may provide focus detection for a full color array.

### BACKGROUND

This relates generally to imaging systems, and more particularly, to multi-array imaging systems.

Modern electronic devices such as cellular telephones, cameras, and computers often use digital image sensors. Imagers (i.e., image sensors) often include a two-dimensional array of image sensing pixels. Each pixel typically includes a photosensor such as a photodiode that receives incident photons (light) and converts the photons into electrical signals.

Some conventional imaging systems include multiple imaging arrays. In particular, some conventional imaging systems include separate red, blue, and green pixel arrays. While such systems may have benefits over monolithic single sensor arrays, conventional multi-array imaging systems leave room for improvement.

It would therefore be desirable to be able to provide improved multi-array image sensor systems and methods.

### BRIEF DESCRIPTION OF THE DRAWINGS

FIG. 1 is a diagram of an electronic device and computing equipment that may include an image sensor system with adjustable multiple exposure capabilities in accordance with embodiments of the present invention.

FIG. 2 is a schematic diagram of a multi-array imaging system that may include a primary imaging array and one or more secondary imaging arrays, which may be arranged around the periphery of the primary imaging array, in accordance with embodiments of the present invention.

FIG. 3 is a schematic diagram of a multi-array imaging system that may include at least one imaging array, which may, as examples, be a hyperspectral imaging array, a polarization sensing array, or a wavefront sensing array, in accordance with embodiments of the present invention.

FIG. 4 is a schematic diagram of a multi-array imaging system that may include at least a first imaging array and a second imagining array that complements the functionality of the first imaging array in accordance with embodiments of the present invention.

FIG. 5 is a schematic diagram of an illustrative polarization sensing imaging array in accordance with embodiments of the present invention.

FIG. 6 is a schematic diagram of illustrative hyperspectral imaging sensors in a hyperspectral imaging array in accordance with embodiments of the present invention.

FIG. 7 is a schematic diagram of an illustrative photosite including vertically stacked photodiodes in accordance with embodiments of the present invention.

FIG. 8 is a schematic diagram of an illustrative wavefront sensing imaging array in accordance with embodiments of the present invention.

FIG. 9 is a block diagram of an imager employing one or more of the embodiments of FIGS. 1-8 in accordance with embodiments of the present invention.

FIG. 10 is a block diagram of a processor system employing the imager of FIG. 9 in accordance with embodiments of the present invention.

### DETAILED DESCRIPTION

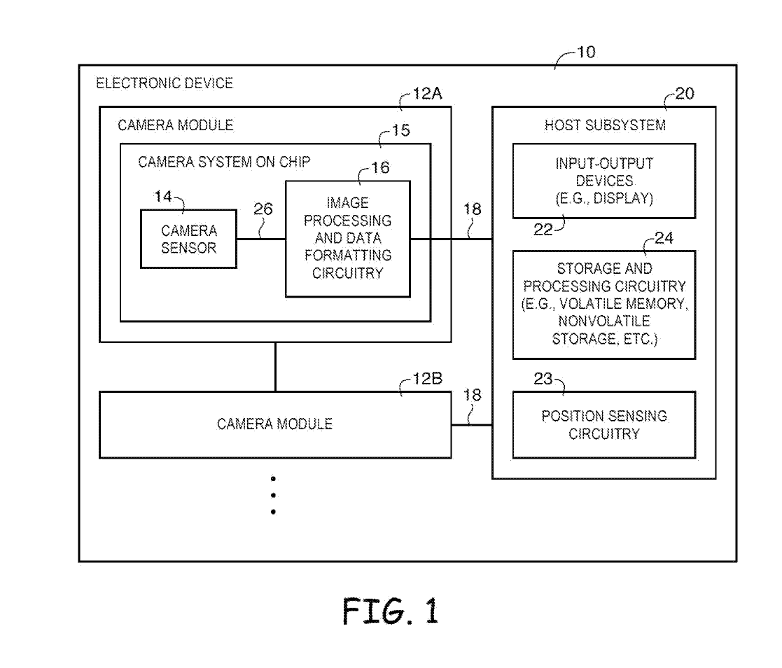

Digital camera modules are widely used in electronic devices. An electronic device with a digital camera module is shown in FIG. 1. Electronic device 10 may be a digital camera, a laptop computer, a display, a computer, a cellular telephone, or other electronic device. Device 10 may include one or more imaging systems such as imaging systems 12A and 12B (e.g., camera modules 12A and 12B) each of which may include one or more image sensors 14 and corresponding lenses. During operation, a lens focuses light onto an image sensor 14. The lens may have fixed aperture. The pixels in image sensor 14 include photosensitive elements that convert the light into digital data. Image sensors may have any number of pixels (e.g., hundreds or thousands or more). A typical image sensor may, for example, have millions of pixels (e.g., megapixels). In high-end equipment, sensors with 10 megapixels or more are not uncommon. In at least some arrangements, device 10 may include two (or more) image sensors 14, which may capture images from different perspectives. When device 10 includes two image sensors 14, device 14 may be able to capture stereo images.

Still and video image data from camera sensor 14 may be provided to image processing and data formatting circuitry 16 via path 26. Image processing and data formatting circuitry 16 may be used to perform image processing functions such as adjusting white balance and exposure and implementing video image stabilization, image cropping, image scaling, etc. Image processing and data formatting circuitry 16 may also be used to compress raw camera image files if desired (e.g., to Joint Photographic Experts Group or JPEG format).

In some arrangements, which is sometimes referred to as a system on chip or SOC arrangement, camera sensor 14 and image processing and data formatting circuitry 16 are implemented as a common unit 15 (e.g., on a common integrated circuit, or stacked together). The use of a single integrated circuit to implement camera sensor 14 and image processing and data formatting circuitry 16 can help to minimize costs. If desired, however, multiple integrated circuits may be used to implement circuitry 15. In arrangements in which device 10 includes multiple camera sensors 14, each camera sensor 14 and associated image processing and data formatting circuitry 16 can be formed on a separate SOC integrated circuit (e.g., there may be multiple camera system on chip modules such as modules 12A and 12B). In other suitable arrangements and when device 10 includes multiple camera sensors 14 (e.g., includes multiple arrays), each camera sensor 14 may be formed on a common integration circuit.

Circuitry 15 conveys data to host subsystem 20 over path 18. Circuitry 15 may provide acquired image data such as captured video and still digital images to host subsystem 20.

Electronic device 10 typically provides a user with numerous high level functions. In a computer or advanced cellular telephone, for example, a user may be provided with the ability to run user applications. To implement these functions, electronic device 10 may have input-output devices 22 such as projectors, keypads, input-output ports, and displays and storage and processing circuitry 24. Storage and processing circuitry 24 may include volatile and nonvolatile memory (e.g., random-access memory, flash memory, hard drives, solid state drives, etc.). Storage and processing circuitry 24 may also include processors such as microprocessors, microcontrollers, digital signal processors, application specific integrated circuits, etc.

Device 10 may include position sensing circuitry 23. Position sensing circuitry 23 may include, as examples, global positioning system (GPS) circuitry, radio-frequency-based positioning circuitry (e.g., cellular-telephone positioning circuitry), gyroscopes, accelerometers, compasses, magnetometers, etc.

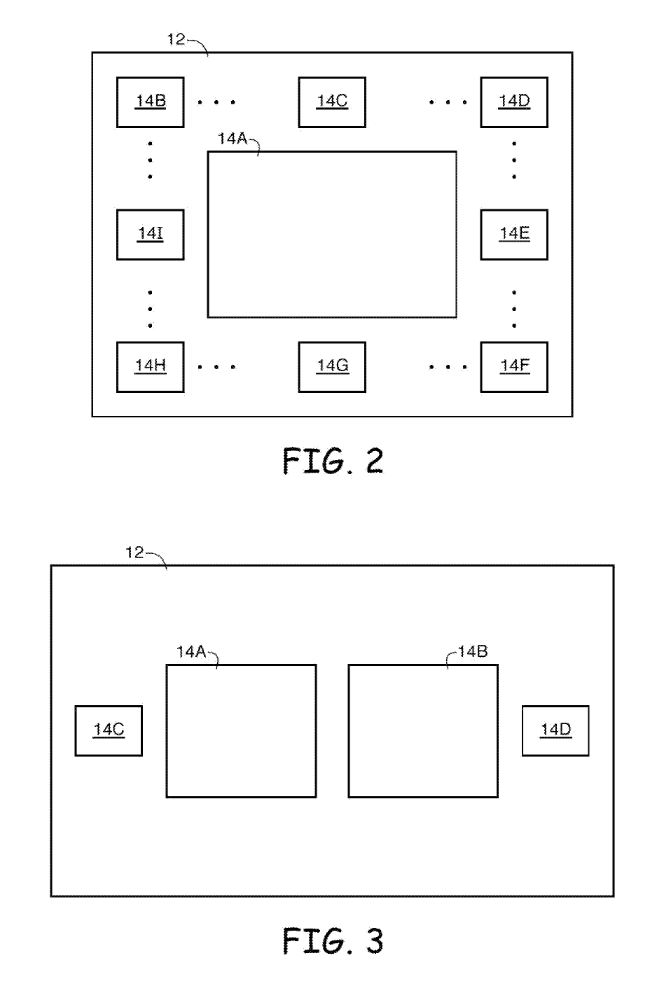

As shown in FIG. 2, device 10 may include a multi-array imaging system that includes at least two arrays such as arrays 14A-141. At least one of the arrays such as array 14A may, if desired, be a basic imaging array having an array of green, red, and blue imaging pixels arranged in a Bayer pattern. Such an array may sometimes be referred to herein as a primary imaging array.

Device 10 may include additional arrays 14B-141, sometimes referred to herein as secondary array. Secondary arrays 14B-141 may be low-power arrays (e.g., each of the arrays 14B-141 may have a lower power consumption that primary arrays such as array 14A). Secondary arrays 14B-141 may have a relative low resolution compared to array 14A. In general, there may be any desired number of secondary arrays 14B-141. As illustrated in FIG. 2, secondary arrays 14B-141 may be arranged around the periphery of primary array 14B (e.g., circularly arranged around primary imaging array 14B).

Secondary arrays 14B-141 may have different functions. In some arrangements, multiple arrays 14B-141 share a similar function and, in other arrangements, each of the arrays 14B-141 has a unique function. One or more of arrays 14B-141 may include focus sensitive imaging pixels such device 10 can obtain focus information from those arrays (e.g., that detects focus depth). The secondary arrays 14B-141 may be configured to continually observe a scene and may trigger other arrays (such as primary array 14A) upon detection of preset conditions in the scene. The pre-set conditions may be based on gesture or interest point tracking or a trigger signal invisible to human vision (e.g., a signal in infrared or ultraviolet wavelengths).

With at least some arrangements, device 10 may include a multi-array imaging system in which at least one of the imaging arrays is a hyperspectral imaging array, a polarization sensing array, or a wavefront sensing array. As illustrated in FIG. 3, a multi-array imaging system may include imaging array 14A, an optional additional imaging array 14B (which may be a basic imaging array having an array of green, red, and blue imaging pixels arranged in a Bayer pattern), and optional low power imaging arrays 14C and 14D (which may be similar to the secondary imaging arrays of FIG. 2). The imaging array 14A may be a hyperspectral imaging array, a polarization sensing array, or a wavefront sensing array, details of which are described below.

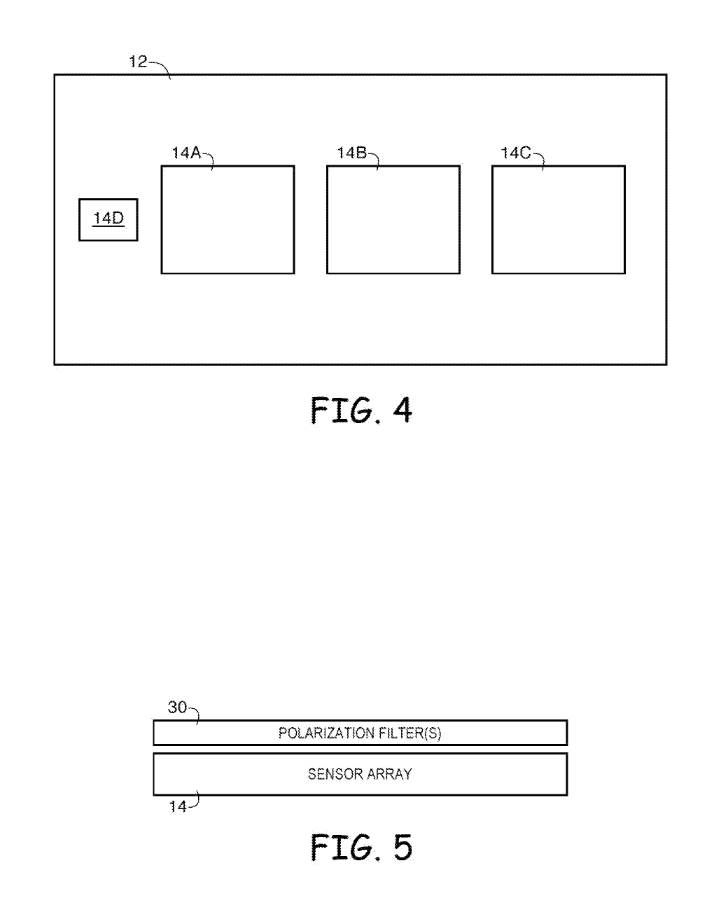

If desired, device 10 may include a multi-array imaging system with complementary imaging arrays. For example and as illustrated in FIG. 4, a multi-array imaging system may include an imaging array 14A, including photosites formed from vertically stacked photodiodes, and at least one additional imaging array 14B. The imaging array 14B may be a monochrome imaging array (e.g., an imaging array that detects only the intensity of incident light summed across visible wavelengths).

In arrangements in which the primary imaging array 14A includes photosites formed from vertically stacked photodiodes and the imaging array 14B is a monochrome imaging array, the primary imaging array 14A may have excellent low light performance and other features. Additionally, the monochrome imaging channel may provide independent luminescent signals that greatly assist in processing images from imaging array 14A. In particular, without the image data from complementary array 14B, imaging array 14A may value inadequate spatial resolution, color resolution, and robustness. By combining image data from array 14A with image data from complementary array 14B, these deficiencies can be overcome.

With other suitable arrangements, imaging array 14B may be a basic imaging array having an array of green, red, and blue imaging pixels arranged in a Bayer pattern. As another example, imaging array 14B may be a non-RBG (i.e., non-Bayer) imaging sensor such as an imaging sensor that includes an array including only one or two of red, blur, and green pixels.

If desired, the multi-array system may include a third imaging array 14C. As one example, the imaging array 14A may be an imaging array including only pixels sensitive to blue light (e.g., an imaging array with a blue filter that extends over all of the pixels), imaging array 14B may be a monochrome imaging array (e.g., an imaging array that detects only the intensity of incident light summed across visible wavelengths), and imaging array 14C may be an imaging array including only pixels sensitive to red light.

As another example, imaging array 14A may be monochrome imaging array, imaging array 14B may be a stacked photodiode imaging array including photosites formed pixels sensitive to a first color and pixels sensitive to a second color (e.g., an arrangement in which red and blue pixels are vertically stacked), and imaging array 14C may be an imaging array including only pixels sensitive to red light.

As illustrated in FIG. 4, the multi-array imaging system of FIG. 4 may also include one or more secondary arrays such as array 14D in manner described above in connection with FIG. 2.

In each of the aforementioned examples of FIG. 4, data from multiple arrays may be combined during image processing to obtain performance better than that provided by any single one of the imaging arrays.

An illustrative polarization sensing imaging array (which may be incorporated into one or more of the embodiments of FIGS. 1-4) is illustrated in FIG. 5. As shown in FIG. 5, camera module 12 may include one or more polarization filters 30 above a sensor array 14. With one suitable arrangement, the polarization filter 30 may be a single filter that passes light having a horizontal polarization (e.g., the left and right direction of the plane of the page of FIG. 5). With other suitable arrangements, polarization filter 30 may be a single filter that passes light having a vertical polarization (e.g., the direction perpendicular to the plane of the page of FIG. 5) or that passes light having either a clockwise or counter-clockwise polarization. If desired, device 10 may include multiple polarization sensing imaging arrays, each of which is sensitive to a particular type of polarized light (e.g., vertically, horizontally, clockwise, or counter-clockwise polarized light).

If desired, the polarization sensing imaging array may include a plurality of polarization filters, each filter being located over a different region of the sensor array 14. The region may be as small as a single image sensing pixel in array 14. Each of the polarization filters may be sensitive to a particular type of polarized light (e.g., vertically, horizontally, clockwise, or counter-clockwise polarized light). With this type of arrangement, a single polarization sensing imaging array may be sensitive to more than one type of polarized light and may be able to image differences in types of polarized light across a scene.

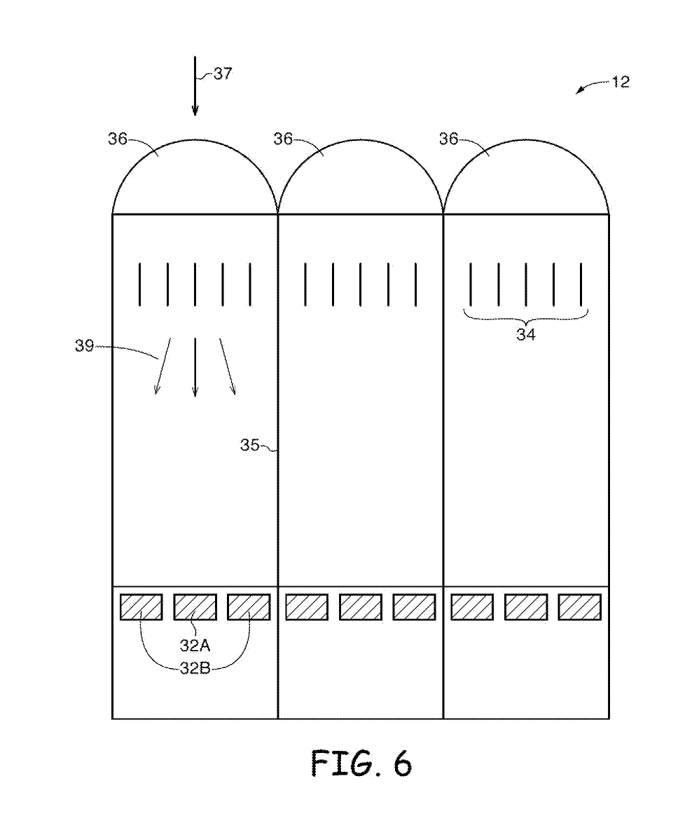

Illustrative hyperspectral imaging sensors that may be part of a hyperspectral imaging array (which may be incorporated into one or more of the embodiments of FIGS. 1-4) are illustrated in FIG. 6. As shown in FIG. 6, hyperspectral imager 14 may be formed from an array of light sensing pixels 32 located underneath gratings 34. Gratings 34 may be diffraction gratings or may be phase gratings (e.g., openings in an opaque layer). Imager 14 may also include microlenses 36 that focuses incident light onto gratings 34. Imager 14 may determine the wavelength of incident light by analyzing the relative intensity of light detected by the light sensing pixels 32 located underneath each of the respective gratings 34.

As shown in FIG. 6, there may be three light sensing pixels 32 per combination of microlens 36 and diffraction gratings 34. With an arrangement of this type, incoming light 37 may be diffracted into light 39, which includes a zero order beam that is received by a central pixel 32A and a first order beam that is received by outer pixels 32B.

If desired, the boundaries 35 between adjacent combinations of microlens 36 and diffraction gratings 34 and the associated imaging pixels may be transparent or opaque (preventing crosstalk).

In arrangements in which the boundaries 35 are transparent, one or more imaging pixels may be shared by adjacent combinations of microlens 36 and diffraction gratings 34 (e.g., may receive light from multiple combinations of microlens 36 and diffraction gratings 34). In such an example, there may be an average of two imaging pixels 32 per combination of microlens 36 and diffraction gratings 34. A first of the imaging pixels may receive a zero order beam while two other imaging pixels (which are each shared with one other combination of microlens 36 and diffraction gratings 34) may receive a first order beam.

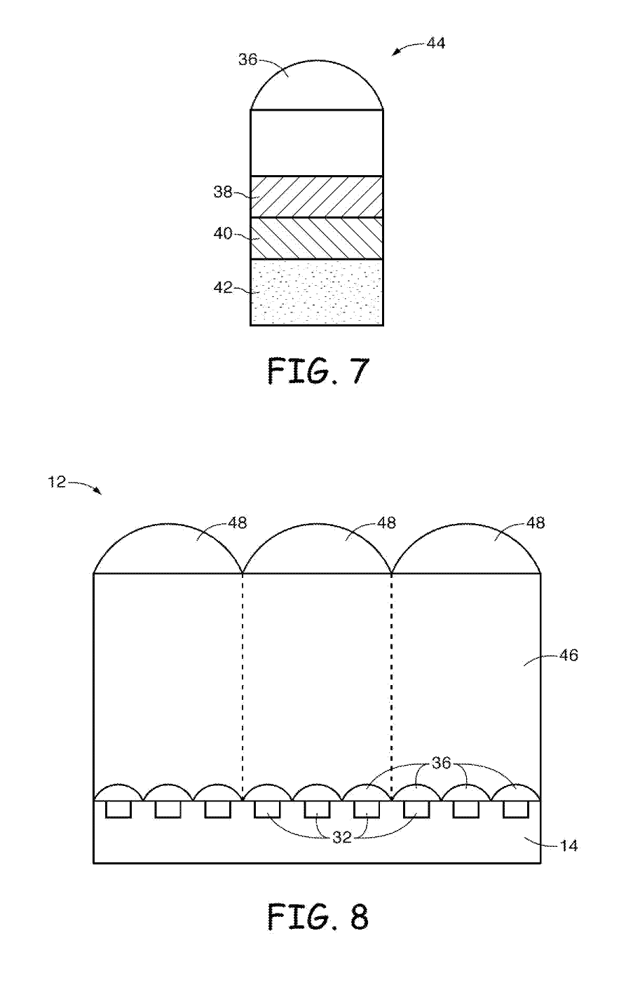

An illustrative photosite in a stacked photodiode imaging array (which may be incorporated into one or more of the embodiments of FIGS. 1-4) is illustrated in FIG. 7. As shown in FIG. 7, photosite 44 may include a microlens 36 that focuses incident light onto underlying two or more photodiodes 38, 40, and 42. Since longer wavelengths of light generally penetrate silicon to a greater depth than shorter wavelengths, the vertical stacking of photodiodes illustrated in FIG. 7 enables color separation without the use of color filters. As one example, photodiode 38 may be sensitive to blue wavelengths, photodiode 40 may be sensitive to green wavelengths, and photodiode 42 may be sensitive to red wavelengths. As a result, a single photosite 44 may be capable of capturing full color data.

An illustrative wavefront sensing imaging array (which may be incorporated into one or more of the embodiments of FIGS. 1-4) is illustrated in FIG. 8. As shown in FIG. 8, camera module 12 may include a sensor array 14 underneath a first micro lens layer 48, separated by a transparent spacer layer 46. The wavefront sensing imaging camera 12 can be used to detect wavefront properties of incident light by measuring the distribution of local light intensity received by array 14 through an array of first micro lenses 48. The wavefront properties may be used for directional wavefront sensing, including focus detection and mapping, which may be used in connection with an adjacent imaging array. As shown in FIG. 8, the wavefront sensing imaging array 12 may include an array of second microlenses 36, each of which is disposed above one or more imaging pixels 32.

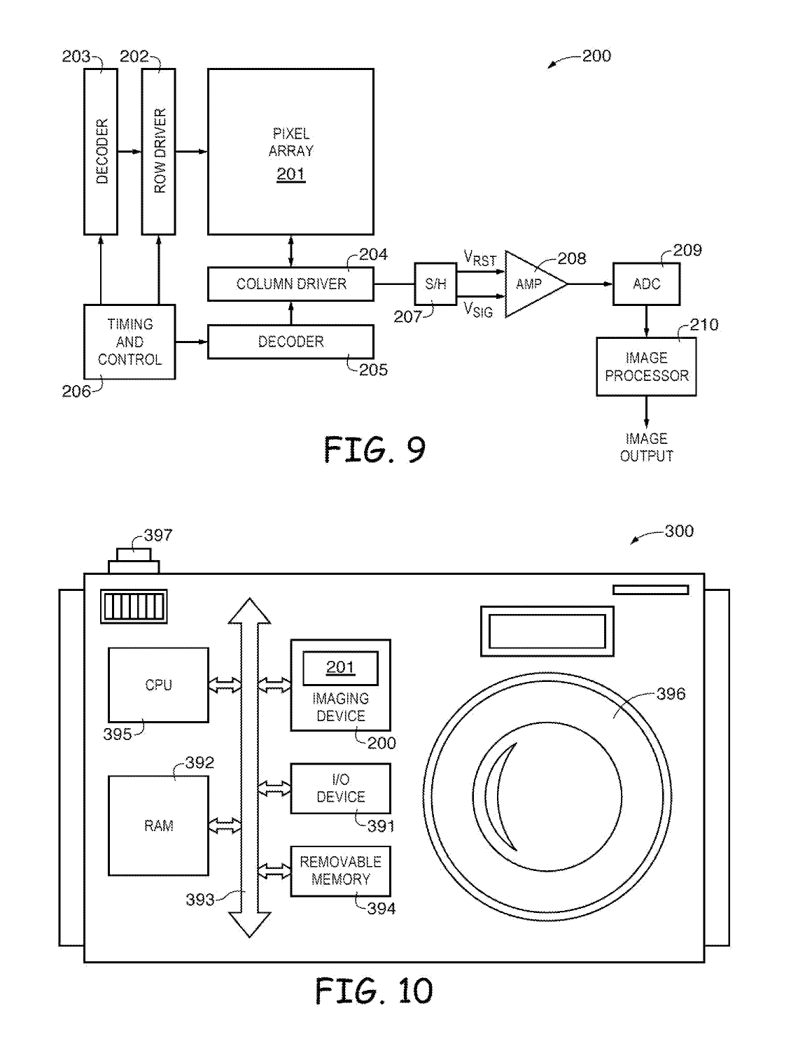

FIG. 9 illustrates a simplified block diagram of imager 200 (e.g., an illustrative one of the imaging arrays in a multi-array imaging system). Pixel array 201 includes a plurality of pixels containing respective photosensors arranged in a predetermined number of columns and rows. The row lines are selectively activated by row driver 202 in response to row address decoder 203 and the column select lines are selectively activated by column driver 204 in response to column address decoder 205. Thus, a row and column address is provided for each pixel.

CMOS imager 200 is operated by a timing and control circuit 206, which controls decoders 203, 205 for selecting the appropriate row and column lines for pixel readout, and row and column driver circuitry 202, 204, which apply driving voltages to the drive transistors of the selected row and column lines. The pixel signals, which typically include a pixel reset signal Vrst and a pixel image signal Vsig for each pixel are sampled by sample and hold circuitry 207 associated with the column driver 204. A differential signal Vrst-Vsig is produced for each pixel, which is amplified by amplifier 208 and digitized by analog-to-digital converter 209. The analog to digital converter 209 converts the analog pixel signals to digital signals, which are fed to image processor 210 which forms a digital image.

FIG. 10 shows in simplified form a typical processor system 300, such as a digital camera, which includes an imaging device such as imaging device 200 (e.g., a multi-array imaging system). Processor system 300 is exemplary of a system having digital circuits that could include imaging device 200. Without being limiting, such a system could include a computer system, still or video camera system, scanner, machine vision, vehicle navigation, video phone, surveillance system, auto focus system, star tracker system, motion detection system, image stabilization system, and other systems employing an imaging device.

Processor system 300, which may be a digital still or video camera system, may include a lens such as lens 396 for focusing an image onto a pixel array such as pixel array 201 when shutter release button 397 is pressed. Processor system 300 may include a central processing unit such as central processing unit (CPU) 395. CPU 395 may be a microprocessor that controls camera functions and one or more image flow functions and communicates with one or more input/output (I/O) devices 391 over a bus such as bus 393. Imaging device 200 may also communicate with CPU 395 over bus 393. System 300 may include random access memory (RAM) 392 and removable memory 394. Removable memory 394 may include flash memory that communicates with CPU 395 over bus 393. Imaging device 200 may be combined with CPU 395, with or without memory storage, on a single integrated circuit or on a different chip. Although bus 393 is illustrated as a single bus, it may be one or more buses or bridges or other communication paths used to interconnect the system components.

Various embodiments have been described illustrating multi-array imaging devices. An imaging system may include multiple imaging arrays. One or more of the arrays may be a low-power array that detects trigger events in observed scenes and, in response to the detection of a trigger event, activates one or more primary imaging arrays. One or more of the arrays may be a polarization sensing array, a hyperspectral array, a stacked photodiode array, a wavefront sensing array, a monochrome array, a single color array, a dual color array, or a full color array. In at least one embodiment, image data from a stacked photodiode imaging array may be enhanced using image data from a separate monochrome imaging array. In at least another embodiment, image data from a wavefront sensing array may provide focus detection for a full color array.

The foregoing is merely illustrative of the principles of this invention which can be practiced in other embodiments.

What is claimed is:

1. A method of operating a multi-array imaging system, comprising:
capturing image data with a stacked photodiode imaging array on a substrate, wherein the stacked photodiode imaging array comprises an array of photosites, each photosite including at least two vertically-stacked photodiodes;
capturing image data with a monochrome imaging array on the substrate; and
with imaging processing circuitry, utilizing luminesce signals in the image data from the monochrome imaging array in processing the image data from the stacked photodiode imaging array.

2. The method defined in claim 1 wherein each photosite in the stacked photodiode imaging array comprises a red photodiode, a green photodiode, and a blue photodiode.

3. The method defined in claim 1 wherein each photosite in the stacked photodiode imaging array comprises a red photodiode, a green photodiode underneath the red photodiode, and a blue photodiode underneath the green photodiode.

4. The method defined in claim 1 wherein utilizing luminesce signals in the image data from the monochrome imaging array in processing the image data from the stacked photodiode imaging array comprises increasing the spatial resolution of the image data from the stacked photodiode imaging array.

5. The method defined in claim 1 wherein utilizing luminesce signals in the image data from the monochrome imaging array in processing the image data from the stacked photodiode imaging array comprises increasing the color resolution of the image data from the stacked photodiode imaging array.

6. A multi-array imaging system comprising:
a primary imaging array on a substrate; and
a plurality of secondary imaging arrays on the substrate, wherein the secondary imaging arrays are arranged around the periphery of the primary imaging array.

7. The multi-array imaging system defined in claim 6 wherein each of the secondary imaging arrays comprises a low power sensor having a power consumption lower than that of the primary imaging array.

8. The multi-array imaging system defined in claim 6 wherein at least one of the secondary imaging arrays comprises a focus depth sensing imager.

9. The multi-array imaging system defined in claim 6 wherein at least one of the secondary imaging arrays comprises an event trigger imaging array, the multi-array imaging system further comprising:
control circuitry coupled to the event trigger imaging array and the primary imaging array, wherein the control circuitry activates the primary imaging array in response a detection of a predetermined condition by the event trigger imaging array.

10. The multi-array imaging system defined in claim 6 wherein the secondary imaging arrays comprise a first secondary imaging array is disposed on a first side of the primary imaging array, a second secondary imaging array is disposed on a second side of the primary imaging array, a third secondary imaging array is disposed on a third side of the primary imaging array, and a fourth secondary imaging array is disposed on a fourth side of the primary imaging array.

11. A multi-array imaging system comprising:
a first imaging array on a substrate; and
a second imaging array on the substrate, wherein the second imaging array comprises one of: a hyperspectral sensing array, a polarization sensing array, and a wavefront sensing array.

12. The multi-array imaging system defined in claim 11 wherein the second imaging array comprises the polarization sensing array.

13. The multi-array imaging system defined in claim 12 wherein the polarization sensing array comprises a single polarization filter over an array of photodiodes.

14. The multi-array imaging system defined in claim 12 wherein the polarization sensing array comprises an array of polarization filters over an array of photodiodes.

15. The multi-array imaging system defined in claim 11 wherein the second imaging array comprises the hyperspectral sensing array.

16. The multi-array imaging system defined in claim 15 wherein the hyperspectral sensing array comprises an opaque layer above an array of photodiodes and comprises an array of sets of gratings in the opaque layer, each set of gratings being located over a respective one of the photodiodes.

17. The multi-array imaging system defined in claim 15 wherein the hyperspectral sensing array comprises a plurality of sets of phase gratings, each set of phase gratings located over a respective set of photodiodes in an array of photodiodes and wherein the hyperspectral sensing array comprises a plurality of microlenses, each of which is located over a respective one of the sets of phase gratings.

18. The multi-array imaging system defined in claim 11 wherein the second imaging array comprises the wavefront sensing array.

19. The multi-array imaging system defined in claim 18 wherein the wavefront sensing array comprises a plurality of first microlenses above an array of light-sensitive pixels and wherein each of the first micro lenses passes light to two or more of the light-sensitive pixels.

20. The multi-array imaging system defined in claim 19 wherein the wavefront sensing array further comprises a plurality of second microlenses above the array of light-sensitive pixels, wherein each of the second microlenses is disposed above and passes light to a respective one of the pixels, and wherein each of the first microlenses is disposed above and passes light to two or more of the second microlenses.

21. The multi-array imaging system defined in claim 20 wherein the wavefront sensing array further comprises a transparent spacer between the plurality of first microlenses and the plurality of second microlenses.
